(19) United States
(12) Patent Application Publication
(10) Pub. No.: US 2009/0092476 A1
(43) Pub. Date: Apr. 9, 2009

(54) METHOD AND APPARATUS FOR ALLOCATING DIFFERENT AUXILIARY MATERIALS TO BE PICKED UP BY A PALLETIZING ROBOT

(75) Inventor: Thomas Salm, Aachen (DE)

Correspondence Address: OSHA LIANG L.L.P., TWO HOUSTON CENTER, 909 FANNIN, SUITE 3500, HOUSTON, TX, 77010, US

(73) Assignee: WINKLER + DUNNEBIER AG, Neuwied (DE)

(21) Appl. No.: 12/246,221

(22) Filed: Oct. 6, 2008

(30) Foreign Application Priority Data
Oct. 4, 2007 (DE) 10 2007 047 405.0

(51) Int. Cl. B65G 61/00

(52) U.S. Cl. 414/801; 414/222.02; 901/50

(57) ABSTRACT

A device is described for providing different auxiliary materials by a palleting robot for palleting objects at a palleting site. A palleting cell has storage sites, and the device is provided with a single supply site. A palleting cell is supplied with the auxiliary materials. The storage sites are arranged at a side of the supply site sequentially in a direction of transportation so that a gap of the auxiliary materials at one of the storage sites is closed by the auxiliary materials that are located at one of the storage sites and/or the supply site in the direction of transportation.

### I. FIELD OF APPLICATION

The present invention relates to a method and a device for providing various auxiliary materials to be picked up by a palleting robot, which pallets arbitrary objects at a palleting site inside a palleting cell. The various auxiliary materials may represent, for example, empty pallets, intermediate layers, or cover layers. The objects to be palleted can be packaged in packaging boxes or other containers or be formed by unpackaged, if applicable stacked, banded products, such as banded stacks of folded box blanks made from cardboard.

### II. TECHNICAL BACKGROUND

It is known to automatically pallet objects inside a so-called palleting cell using a palleting robot. During the palleting process several auxiliary materials are necessary, to which the palleting robot must have access, if necessary. For example, the palleting robot requires empty pallets, intermediate layers arranged between certain layers of objects to be palleted in order to stabilize the pallet structure, as well as cover layers provided with a bent edge, if necessary comprising a more solid material than the intermediate layers, and arranged on the uppermost layer of objects.

Inside the palleting cells known a separate storage site is provided for each auxiliary material which the palleting robot accesses. As soon as a certain auxiliary material is completely consumed it is resupplied to the respectively empty storage site via a supply site allocated thereto and located outside the palleting cell. For this purpose an operator of the palleting cell positions a stack of the respective auxiliary material to the supply site, which is then transported, for example via a roller conveyer device, from the supply site of the empty storage site. In order to allow supplying each storage site the known palleting cells of each storage site are allocated to a separate supply site.

At the erection sites of palleting cells the spatial conditions are frequently tight. In spite of tight spatial conditions the known palleting cells always require that a number of the supply sties outside the palleting cell are implemented according to the number of necessary auxiliary materials. This is disadvantageous in that here useful moving space is taken from the floor transportation vehicles, by which the materials are positioned on the supply sites.

### III. DESCRIPTION OF THE INVENTION

a) Technical Object

Therefore the object of the present invention is to provide a method and a device for providing different auxiliary materials for pickup by a palleting robot, which requires as little space as possible at the erection site of the palleting cell.

b) Solution of the Object

This object is attained by a method and/or a device having the features of claim 1 and/or 10. Additional embodiments of the present invention are explained in the sub-claims.

According to the invention it is suggested to feed precisely that auxiliary material to the palleting cell via a single supply site that has been completely consumed at the storage sites during palleting. The single supply site and several storage sites are here arranged in a transportation direction side-by-side along a path not necessarily straight and a material gap and/or void developing by the material consumed at a certain storage site is closed by a gradual locally moving down in the direction of transportation of the auxiliary material or those auxiliary materials located at one or more positions upstream the material gap, in the direction of transportation, i.e. located at the supply site or at the supply site and one or more storage sites. The arrangement of the supply sites and the storage sites following each other in the direction of transportation in the sense of the present invention represent that the above-mentioned sites are arranged “serially” in the way of electric resistors. The paths along which the supply site and the storage sites are arranged can be straight, curved, or extend in any other way provided with curves.

The material gap can occur at an arbitrary storage site. When it occurs at a storage site immediately adjacent to the supply site only a one-step moving up of the stack of auxiliary material occurs, which is positioned on the supply site. Therefore only a single auxiliary material moves up. When the material gap occurs at a different storage site at least two stacks of different auxiliary materials move up one space each, i.e. at least the auxiliary located on the supply site moves up one space and the material located at the first storage site immediately adjacent to the first site. This shows that within the scope of the present invention the auxiliary material located on the supply site will always move up to close the material gap, while the moving up of auxiliary material or materials in the area of the storage sites depends on the storage site the material gap develops. A material gap developing at the last storage site, having only one adjacent storage site, is also called a material gap in the sense of the present invention.

According to the invention the advantage is achieved that no space is necessary for several supply sites and/or that the space for several supply sites used in prior art can be used for other purposes, for example as moving space for ground transportation vehicles.

Within the scope of the present invention it is necessary that the control of the palleting robot is informed which auxiliary material is presently located at each storage site, in order to correctly execute the access to the individual storage sites according to the need for auxiliary materials during the palleting process.

For this purpose, for example, a collection device with a sensor mechanism can be provided; recording the material located at each storage site and how the occupation of the individual storage sites changes, if applicable, after a material gap was closed by a gradual moving up in the sense of the present invention. The collection device can automatically report the information gathered via the sensor mechanism concerning the present occupation of the storage sites with auxiliary materials to the electronic control of the palleting robot so that said robot can access certain materials as needed.

A collection device can be omitted, though, when the entire palleting process of a palleting order can be entirely pre-programmed in the electronic control of the palleting robot. This requires, on the one hand, that the palleting structure including the images of positions, i.e. the geometry of the arrangement of the objects to be palleted on the pallet and the arrangement of the intermediate layers, can be predetermined and, on the other hand, that the amount of the individual auxiliary material items per material stack always remains constant and is known. In this case the sequence of the necessary access by the palleting robot to the storage sites as well as the closing of the material gaps according to the invention developing during the palleting process can be completely pre-calculated and accordingly preprogrammed.

Preferably, in the proximity of the supply site it is optically and/or acoustically displayed to the operator of the palleting cell which material is to be positioned at the respective supply site. This way the probability of the operator positioning the wrong material is minimized.

During palleting different auxiliary materials are frequently requested in different amounts. For example, for creating a loaded pallet one empty pallet and several intermediate layers may be necessary. This means that the palleting robot accesses the provided intermediate layers at shorter temporal intervals than the provided pallets. It is possible that the access clock for the intermediate layers provided in the palleting cell are shorter than the period necessary for intermediate layers to be re-supplied to the storage site via the supply site after the complete consumption of the intermediate layers. Therefore at least for auxiliary material most frequently requested in the palleting cell temporarily a supply shortage can occur.

In order to close this supply shortage, preferably at least the most frequently requested auxiliary material is temporarily stored at an interim storage site arranged inside the palleting cell. The interim storage site can be located at the bottom of the palleting cell or, for reasons of minimizing the floor space of the palleting cell, at a location distanced from the floor. Only some of the most frequently requested auxiliary materials must be provided at the interim storage site.

If during the supply shortage the respective auxiliary material is being requested, and the palleting robot cannot fetch it from a storage site, it can access the interim storage site. Furthermore, the palleting robot itself can restock the interim storage site when, on the one hand, the respective material is available again at the supply site and, on the other hand, it is possible during an idle moment to transport the respective material from one of the storage sites to the interim storage site. An idle period develops for the palleting robot, for example, when a pallet has been completely filled at the palleting location with the objects to be palleted and remains to be removed from the palleting site.

The various auxiliary materials are generally provided in stacks so that the respective stack is located on the supply site and/or the storage sites. Here it is possible that it relates to stacks comprising exclusively the respective materials called uniform stacks in the following. The uniform stacks can be consumed entirely during palleting without any remnants different than the material remaining, such as a carrier pallet for carrying an auxiliary material, remaining at the storage site. The feeding of uniform stacks into the palleting cell is therefore advantageous because here, with regard to certain auxiliary materials, different remnants must be handled.

For practical reasons it is frequently practical, though, to arrange certain auxiliary materials, for example intermediate layers, on a carrier pallet in order to allow a better handling of material stacks outside the palleting cell, particularly when placing it to the supply site. Here the carrier pallet in its embodiment is generally identical to empty pallets provided at one of the storage sites for palleting the objects.

One of the auxiliary materials provided preferably refers to empty pallets. If at one of the storage sites a material stack arranged on a carrier pallet comprises a different material and this material is completely consumed during palleting so that only the respective carrier pallet remains at the storage site, the particularly advantageous possibility develops according to the invention, in particular, that the carrier pallet is either put onto a pallet stack located at a different storage site, using the palleting robot, or to arrange it immediately at the palleting site, if here a need for an empty pallet is given at the time. This way the carrier pallet is introduced into the palleting process occurring in the palleting cell and requires no removal from the palleting cell for emptying the respective storage site, with a separate removal opening had to be provided in the latter case. After the entire clearing of the respective storage site the respective auxiliary material can be once more supplied according to the invention via the supply site.

The type and number of auxiliary materials depend on the needs of the concrete palleting process. For example, precisely two auxiliary materials can be provided at precisely two storage sites, with the materials may relate to pallets and intermediate layers or pallets and cover layers or intermediate layers and cover layers. However, more than two auxiliary different materials, for example precisely three materials in the form of pallets, intermediate layers, and cover layers, may be provided in precisely three storage sites in the palleting cell.

c) Exemplary Embodiments

In the following, an embodiment of the present invention is described as an example, using the attached drawings. It shows:

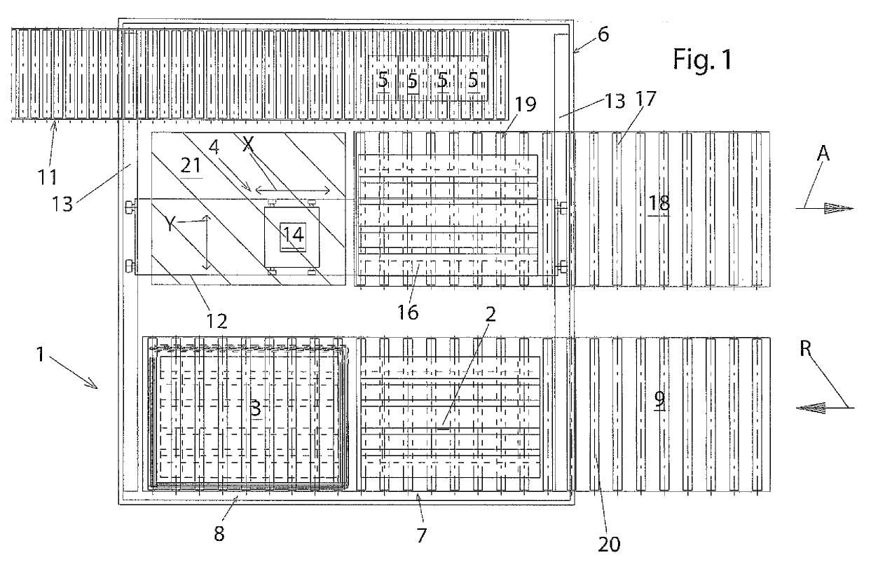

FIG. 1: a top view of a palleting cell having a device according to the invention, and

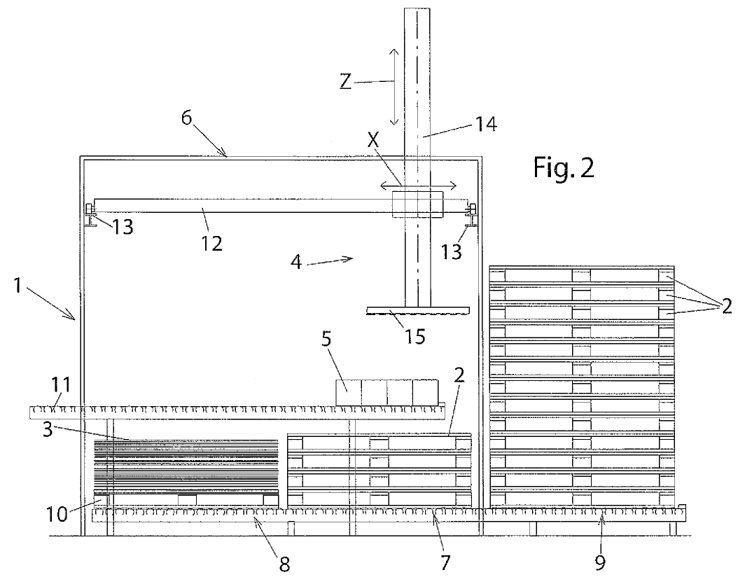

FIG. 2: a side view of a palleting cell having a device according to the invention.

FIG. 1 shows a device 1 according to the invention comprising a palleting cell 6, preferably embodied as a metal construction, and preventing for occupational safety reasons that during palleting an operator, knowingly or unknowingly, enters the interior space. The palleting space 6 is arranged at the end of a production machine, not shown, which produces the objects 5 to be palleted, for example in the form of packaging boxes, in which envelopes are located. As discernible in FIGS. 1 and 2 the objects 5 are moved via a roller conveyer table 11 into the interior of the palleting cell 6.

In the embodiment shown, a palleting robot 4 is embodied as a portal robot inside the palleting cell 6. The palleting robot 4 comprises a portal carrier 12 that can be displaced on rails 13 in the directions according to the double-arrow Y in FIG. 1. Furthermore, it is provided with a lift arm 14, mobile in the directions according to the double-arrow Z in FIG. 2, which in turn is displaceable on the portal carrier 12 in the directions according to the double-arrow X in FIGS. 1 and 2. Accordingly, a robot head 15, mounted at the lower end of the lift arm 14, can approach each spatial point inside the palleting cell 6. The robot head 15 can be embodied as a suction head, for example, which via a vacuum can hold and release the objects 5, for example.

FIG. 1 shows a palleting site 19 located inside the palleting cell 6, at which in FIG. 1 presently an empty pallet 16 is located. On the empty pallet 16, a palleting robot 4 stacks various layers of objects 5 to be palleted. After the palleting process is finished, the completely loaded pallet 16 is moved with the help of a roller conveyer device 17 to a pick-up site 18 located outside the palleting cell 6, it can be removed, for example via a forklift, in the removal direction A.

In the exemplary embodiment shown, precisely two storage sites 7, 8 for precisely two auxiliary materials are provided in the palleting cell 6. The materials refer to pallets 2, on the one hand, and intermediate layers 3 made from paper, carton, cardboard, corrugated cardboard or similar materials, on the other hand. As discernible in FIG. 2, a stack of four pallets 2 is located at the first storage site 7, while a stack of a multitude of intermediate layers 3 is arranged at the second storage site 8. After the completely loaded pallet 16 has left the palleting site 19 in the direction of the pick-up site 18 the palleting robot 4 with its robot head 15 grabs the uppermost pallet 2 of the pallet stack located at the first storage site 7 and transports the uppermost pallet 2 to the palleting site 19. Subsequently it creates one or more layers of objects 5 on the pallet now located on the palleting site 9 until the predetermined pallet load requires for the first time the placement of an intermediate layer 3.

Accordingly, the robot head 15 approaches the second storage site 8, where a stack of intermediate layers 3 is located. The uppermost intermediate layer 3 is grasped by the robot head 15 and placed onto the most recently created layer of objects 5 on the palleting site 9. Subsequently another structure of one or more layers of objects 5 is placed onto the positioned intermediate layer 3.

The above-described processes are repeated several times so that again and again completely palleted pallets can be picked up at the pick-up site 18.

Frequently, the predetermined pallet structure provides several intermediate layers 3 for each completely loaded pallet. Therefore, the intermediate layers 3 are more frequently requested than the pallets 2. However, in the same storage volume a lot more relatively thin intermediate layers 3 than pallets 2 can be provided. In other words: the stack of pallets 2 and/or intermediate layers 3 shown in FIG. 2 at the storage site 7 and/or 8 are approximately of equal height, however the stack of pallets 2 located at the storage site 7 will be consumed earlier during the palleting process, in spite of lower demand for pallets 2, than the intermediate layers 3 located at the storage site 8. As soon as the pallets 2 inside the palleting cell 6 have been completely consumed it is necessary to provide more pallets 2 at the storage site 7.

In order to feed a new stack of pallets 2 to the palleting cell 6 the stack shown in FIG. 2 at the very right is placed to the supply site 9 located preferably outside the palleting cell 6, for example with the help of a forklift. Via a roller conveyer device 20 the placed stack of pallets 2 is then transported to the first storage site 7, where the palleting robot 4, when needed, can once more access empty pallets 2.

After the palleting robot 4 has executed additional palleting processes finally at some point of time all intermediate layers 3 originally positioned at the storage site 8 have been consumed. At the storage site 8 merely a carrier plate 10 remains, on which the consumed intermediate layers 3 had been positioned. In order to completely empty the storage site 8 now the robot head 15 approaches, grasps the carrier pallet 10, and places it onto the uppermost pallet 2 of the (remaining) stack of pallets 2 still located in the storage site 7. As soon as another need for empty pallets 2 is given the palleting robot 4 can now access the carrier pallet 10, now serving as a pallet 2 provided. Alternatively there is the chance that the carrier pallet 10 is transported from the storage site 8 directly to the palleting site 19, if here need for an empty pallet is given at this time.

In order to close the gap of intermediate layers existing at the storage site 8 a new stack of intermediate layers 3 is placed to the supply site 9, which in turn may be positioned on a carrier pallet. Subsequently the (remaining) stack of pallets 2 still located at the storage site 7 and the stack of intermediate layers 3 located on the supply site 9, using the help of the roller conveyer device 20, are transported one space to the left in FIGS. 1 and 2 so that the (remaining) stack of pallets 2 comes to rest at the storage site 8 and the new stack of intermediate layers 3 is located at the storage site 7.

This way, the palleting robot 4 is once more provided with both pallets 2 as well as intermediate layers 3 inside the palleting cell 6. Its electronic control must only ensure that it no longer accesses the storage site 7 for a pallet 2 needed but the storage site 8, and when an intermediate layer 3 is needed no longer the storage site 8 but the storage site 7. This could be ensured by a detection device, which optically detects the actual loading of the storage sites 7 and 8 with pallets 2 or intermediate layers 3, for example, and sends this information to the robot control.

As soon as during the further progression of palleting the last pallet 2 has been placed on the storage site 8 the pallet gap developing here must be closed. For this purpose the supply site 9 must be once more provided with a new stack of pallets 2. The roller conveyer device 20 then transports the (remaining) stack of intermediate layers 3 still located in the storage site 7 in FIGS. 1 and 2 and the new stack of pallets 2 located on the supply site 9 one position to the left each so that the intermediate layers 3 come to rest at the storage site 8 and that the new stack of pallets 2 is located at the storage site 7. This way, once more the loading of the storage sites 7 and 8 with pallets 2 and/or intermediate layers 3 is achieved as shown in FIG. 1. The robot control receives a respective signal concerning the changed positions and the palleting robot 4 can once more access pallets 2 or intermediate layers 3 as needed.

As discernible in FIGS. 1 and 2 in the exemplary embodiment shown the single supply site 9 and the two storage sites 7, 8 are arranged side-by-side in a straight line. The moving up to close a pallet or intermediate layer gap developing at the storage sites 7 or 8 always occurs in the transportation direction R, i.e. in the figures from the right to the left. Here, those pallets and/or intermediate layers located in the direction of transportation R downstream the pallet or intermediate layer gap move up, which are located in the direction of transportation R downstream the pallet or intermediate layer gap, i.e. in FIGS. 1 and 2 at the right in reference to the pallet or intermediate layer gap. Depending on the storage sites 7 or 8 developing the gap of pallets or intermediate layers develops either one or two stacks move up to the left in the direction of transportation R. When the gap of pallets or intermediate layers moves up to the storage site 7 exclusively the new stack of pallets 2 or intermediate layers 3 located on the supply site 9 moves up. When the gap of pallets or intermediate layers occurs at the storage site 8, two stacks move up to the left in the direction of transportation R, namely the (remaining) stack of pallets 2 or intermediate layers 3 located at the storage site 7 and the new stack of pallets 2 or intermediate layers 3 located at the supply site 9.

According to the invention in a space-saving manner only a single supply site 9 is necessary, by which the pallets 2 or intermediate layers 3 are supplied to the palleting cell 6. The pallets 2 or intermediate layers 3 reaching the storage site 8 were previously always located at the storage site 7, so that the storage site 7 can be considered as a type of traffic site located inside the palleting cell 6 to supply the storage site 8 with pallets 2 or intermediate layers 3. This also leads to an advantageous space saving effect inside the palleting cell 6.

In FIG. 1 an intermediate storage site 21 is discernible arranged at the bottom of the palleting cell 6, which serves in the exemplary embodiment shown to temporarily store intermediate layers 3. The palleting robot 4 itself can fill the intermediate storage site 21 with some intermediate layers 3 taken depending on the present fill of the storage site 7 or 8.

When in the palleting cell 6 a gap of intermediate layers develops which has not been closed by a supply of new intermediate layers 3 and additionally the palleting process to be executed requires an intermediate layer 3 the palleting robot 4 can access the intermediate storage site 21 in order to satisfy the need. Thus, the palleting process is not interrupted until the palleting cell 6 is resupplied with intermediate layers 3.

### List of Reference Characters

1 Device

2 Pallet

3 Intermediate layer

4 Palleting robot

5 Object

6 Palleting cell

7 first storage site

8 second storage site

9 Supply site

10 Carrier pallet

11 Roller conveyer table

12 Portal carrier

13 Rails

14 Lift arm

15 Robot head

16 Empty pallet

17 Roller transportation device

18 Pick-up site

19 Palleting site

20 Roller transportation device

21 Interim storage site

A Removal direction

R Direction of transportation

1. A method for providing different auxiliary materials for pick-up by a palleting robot for palleting objects at a palleting site in a palleting cell, with several storage sites being provided inside the palleting cell for the purpose to accept different auxiliary materials and which the palleting robot accesses during palleting, wherein
the palleting cell is supplied via a single supply site with the respective auxiliary material which had been completely consumed during palleting at one of the storage sites, with the storage sites being arranged in the direction of transportation side-by-side on the supply site and a gap of auxiliary materials that developed by the material being consumed at a certain storage site being closed by a moving up of that auxiliary material and/or those materials in the direction of transportation which is/are located at one or more locations positioned in the direction of transportation upstream the material gap.

2. The method according to claim 1, wherein
in the area of the supply site it is optically and/or acoustically displayed for the operator of the palleting cell which material is to be positioned on the supply site.

3. The method according to claim 1, wherein
at least the auxiliary material most frequently requested in the palleting cell is temporarily stored at an interim storage site arranged inside the palleting cell in order to allow satisfying the potential need for said auxiliary material arising during palleting after this auxiliary material has been consumed and prior to it being resupplied.

4. The method according to claim 1, wherein
one of the auxiliary materials is provided in the form of pallets and one of more of the other auxiliary materials is and/or are provided on a carrier pallet with the carrier pallet being used as a pallet within the scope of palleting the objects.

5. The method according to claim 1, wherein
precisely two auxiliary materials are provided at precisely two storage sites.

6. The method according to claim 5, wherein
the auxiliary materials represent pallets on the one hand and intermediate layers on the other hand.

7. The method according to claim 5, wherein
the auxiliary materials represent pallets on the one hand and cover layers on the other hand.

8. The method according to claim 5, wherein
the auxiliary materials represent intermediate layers on the one hand and cover layers on the other hand.

9. The method according to claim 1, wherein
precisely three auxiliary materials are provided in the form of pallets, intermediate layers, as well as cover layers at precisely three storage sites.

10. A device for providing different auxiliary materials for pick-up by a palleting robot for palleting objects at a palleting site comprising a palleting cell in which several storage sites being provided, which are determined for accepting different materials and which the palleting robot accesses during the palleting process, wherein
the device is provided with a single supply site, by which the palleting cell can be supplied with that auxiliary material which had been entirely consumed at one of the storage sites during palleting, with the storage sites being arranged in reference to the supply site sequentially in the direction of transportation so that a gap of auxiliary material consumed at a certain storage site can be closed by that material and/or those materials moving up in the direction of transportation that they are located at one or more sites upstream the material gap in the direction of transportation.

11. The device according to claim 10, wherein
an optic and/or acoustic signal device is arranged in the area of the supply site, by which the operator of the palleting cell is shown which material must be supplied to the supply site.

12. The device according to claim 10, wherein
inside the palleting cell at least one interim storage site is arranged for temporarily storing at least the most frequently requested auxiliary materials in order to satisfy any existing need for these materials during palleting, if necessary, after their consumption and prior to their re-supply.

13. The device according to claim 10, wherein
precisely two storage sites are provided for precisely two auxiliary materials.

14. The device according to claim 10, wherein
precisely three storage sites are provided for precisely three auxiliary materials.

15. The method according to claim 2, wherein
at least the auxiliary material most frequently requested in the palleting cell is temporarily stored at an interim storage site arranged inside the palleting cell in order to allow satisfying the potential need for said auxiliary material arising during palleting after this auxiliary material has been consumed and prior to it being resupplied.

16. The method according to claim 2, wherein
one of the auxiliary materials is provided in the form of pallets and one of more of the other auxiliary materials is and/or are provided on a carrier pallet with the carrier pallet being used as a pallet within the scope of palleting the objects.

17. The method according to claim 3, wherein
one of the auxiliary materials is provided in the form of pallets and one of more of the other auxiliary materials is and/or are provided on a carrier pallet with the carrier pallet being used as a pallet within the scope of palleting the objects.

18. The method according to claim 2, wherein
precisely two auxiliary materials are provided at precisely two storage sites.

19. The method according to claim 3, wherein
precisely two auxiliary materials are provided at precisely two storage sites.

20. The method according to claim 4, wherein
precisely two auxiliary materials are provided at precisely two storage sites.
